(19) United States
(12) Patent Application Publication
(10) Pub. No.: US 2025/0141286 A1
(43) Pub. Date: May 1, 2025

(54) A ROTOR TOPOLOGY FOR VERY HIGH SPEED PERMANENT MAGNET MACHINES

(71) Applicant: NewSouth Innovations Pty Limited, Sydney (AU)

(72) Inventors: Guoyu Chu, Sydney (AU); Rukmi Dutta, Sydney (AU); Fazlur Rahman, Sydney (AU)

(73) Assignee: NewSouth Innovations Pty Limited, Sydney (AU)

(21) Appl. No.: 18/832,059

(22) PCT Filed: Jan. 23, 2023
(86) PCT No.: PCT/AU2023/050038

§ 371 Date: Jul. 22, 2024

(30) Foreign Application Priority Data
Jan. 25, 2022 (AU) 2022900134

(51) Int. Cl. H02K 1/276

(52) U.S. Cl. CPC H02K 1/276

(57) ABSTRACT

A multi-pole interior permanent magnet motor rotor 1 has an annulus 2 with an outer radius 3 and an inner radius 4 that form aperture 5 configured to receive a motor shaft 6 therethrough. The rotor has four quadrants 7 where each includes a pair of permanent magnet apertures 8,9 symmetrically disposed about a quadrant centreline 10 that extends radially from the centre of the annulus 2 to the outer radius 3 equally dividing each quadrant 7. Each permanent magnet aperture 8,9 is disposed each side of the centreline 10 and each aperture 8,9 has a proximal end 11 adjacent the centreline 10 and an opposing distal end 12. A flux barrier aperture 13 is associated with each permanent magnet aperture 8,9 wherein each flux barrier aperture 13 is disposed intermediate a permanent magnet aperture 8,9 and the rotor outer radius 3 adjacent to the distal end 12 of the associated permanent magnet aperture 8,9. The rotor includes a primary bridge 15 disposed intermediate the permanent magnet aperture 8,9 and the flux barrier aperture 13 whereby the primary bridge 15 has a predetermined thickness and a secondary bridge 16 disposed intermediate the flux barrier aperture 13 and the rotor outer radius 3 wherein the secondary bridge 16 has a predetermined thickness that is less than the primary bridge 15 thickness.

### FIELD

The invention relates to electric motors and, in particular, to an improved permanent magnet motor and rotor element for use therewith.

The invention has been developed primarily with respect to a high-speed interior (internal) permanent magnet synchronous motor and will be described hereinafter with reference to this application.

### BACKGROUND

A conventional and well-known electric motor type is the AC induction motor (IM) in which a rotating field is generated by a stator winding. When the field rotates, a current is induced in rotor bars requiring an angular speed difference between the rotor and the magnetic field. The interaction between the two produces the torque to rotate the shaft.

A well-known variation of the AC induction motor is known as a permanent magnet motor. This uses magnets attached to or imbedded within into the rotor surface. The magnets are used to generate a constant magnetic flux instead of requiring the stator field to generate one by linking to the rotor, as is the case with an induction motor. A fourth motor known as a line-start PM (LSPM) motor incorporates characteristics of both motors.

In recent years, high-speed interior permanent-magnet synchronous machines (IPMSM) are getting substantial attention in the industry and research field. First, IPMSM has the inherent merits of high efficiency, compact structure, and excellent controllability. Second, in high-speed applications, IPMSM outperforms surface-mounted permanent-magnet synchronous machines (SPMSM) due to its extensive constant-power speed ratio (CPSR), additional reluctance torque, and lower risk of demagnetization. Also, high speed is desirable and is one of the major development trends of mesoscale drive systems.

In Gerada, et al, “High-Speed Electrical Machines: Technologies, Trends and Developments,” IEEE Transactions on Industrial Electronics, vol. 61, no. 6, pp. 2946-2959 June 2014, there is disclosed a very detailed literature review on high-speed electrical machines designed before 2013. The authors concluded that PM machines are suitable for low-power and high-speed applications. In 2013, the high-speed limit of SPMSM with retaining sleeves was 8×10⁵ rpmvkw; the limit of IPMSM using high strength Si—Fe laminations was 1.5×10⁵ rpm Vkw.

The limit of IPMSM was achieved by the motor developed as disclosed in Y. Honda et al, “Using the Halbach magnet array to develop an ultrahigh-speed spindle motor for machine tools,” IEEE-IAS '97—Conference Record of the 1997 IEEE Industry Conference/Thirty-Second IEEE-IAS Annual Meeting, Vols 1-pp. 56-60, 1997 having a maximum speed of 50,000 rpm at the rated power of 11 kW. It is clear that the development of high-speed IPMSM is behind SPMSM in the high-speed field, despite the fact that IPMSM has many desired characteristics for high-speed operations. This limitation is due to the high mechanical stress experienced by the thin iron bridges of an IPMSM.

The genesis of the invention is a desire to provide an interior permanent magnet motor that will overcome one or more of the disadvantages of the prior art, or to provide a useful alternative.

### SUMMARY OF INVENTION

According to a first aspect of the invention there is provided multi-pole interior permanent magnet motor rotor comprising an annulus having an outer radius and an inner radius forming an aperture configured to receive a motor shaft therethrough, the rotor having four quadrants wherein each quadrant includes a pair of permanent magnet apertures symmetrically disposed about a quadrant centreline extending radially from the centre of the annulus to the outer radius equally dividing each quadrant such that each permanent magnet aperture is disposed each side of the centreline and each aperture having a proximal end adjacent the centreline and an opposing distal end, a flux barrier aperture associated with each permanent magnet aperture wherein each flux barrier aperture is disposed intermediate a permanent magnet aperture and the rotor outer radius adjacent to the distal end of the associated permanent magnet aperture, the rotor including a primary bridge disposed intermediate the permanent magnet aperture and the flux barrier aperture wherein the primary bridge has a predetermined thickness and a secondary bridge disposed intermediate the flux barrier aperture and the rotor outer radius wherein the secondary bridge has a predetermined thickness that is less than the primary bridge thickness.

According to another aspect of the invention there is provided a multi-pole interior permanent magnet motor rotor comprising an annulus having an outer radius and an inner radius forming an aperture configured to receive a motor shaft therethrough, the rotor having 2N equi-sized sectors where N is an integer equal to or greater than 1, each sector including a pair of permanent magnet apertures symmetrically disposed about a sector centreline and extending radially from the centre of the annulus to the outer radius equally dividing each sector such that each permanent magnet aperture is disposed each side of the centreline and each aperture having a proximal end adjacent the centreline and an opposing distal end, a flux barrier aperture associated with each permanent magnet aperture wherein each flux barrier aperture is disposed intermediate a permanent magnet aperture and the rotor outer radius adjacent to the distal end of the associated permanent magnet aperture, the rotor including a primary bridge disposed intermediate the permanent magnet aperture and the flux barrier aperture wherein the primary bridge has a predetermined thickness and a secondary bridge disposed intermediate the flux barrier aperture and the rotor outer radius wherein the secondary bridge has a predetermined thickness that is less than the primary bridge thickness.

Advantageously, when compared to conventional flat-type and V-type interior permanent magnet motors, the present invention provides significantly improved mechanical robustness, which allows IPMSMs using this technology to operating at very high speeds.

### BRIEF DESCRIPTION OF DRAWINGS

A preferred embodiment of the invention will now be described, by way of example only, with reference to the accompanying drawings in which:

FIG. 1 is a front view of an interior permanent magnet motor rotor according to the preferred embodiment of the invention;

FIG. 2 is a front view of the quadrant of the rotor of FIG. 1;

FIG. 3 is a schematic view of the rotor of FIG. 2;

FIG. 4 is a technical illustration of the rotor of FIG. 1;

FIG. 5 is a cross-section schematic view of an interior permanent magnet motor having the rotor of FIG. 1;

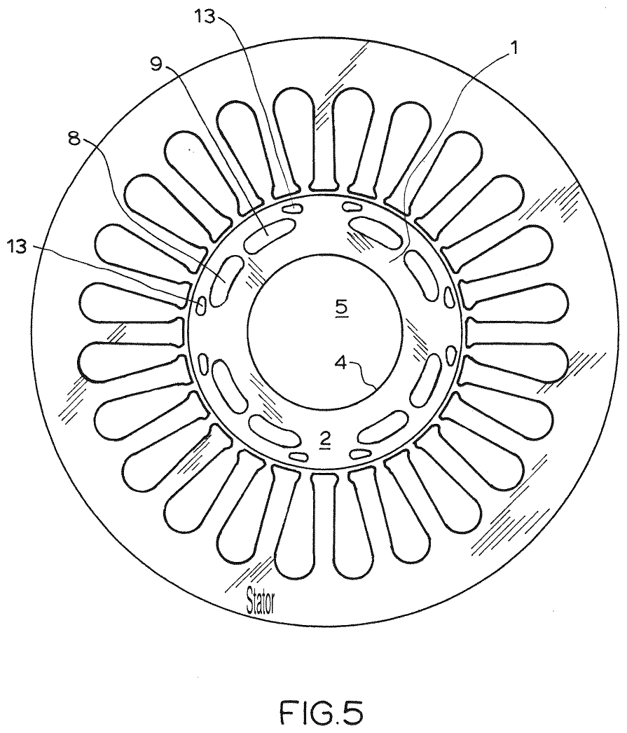

FIG. 6 is a schematic view of the stator of the motor of FIG. 5;

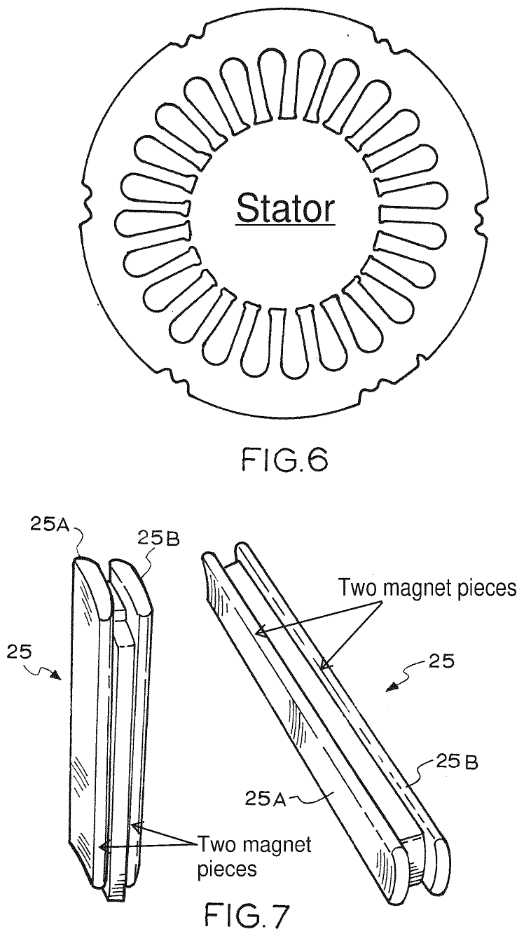

FIG. 7 is a photo of a pair of permanent magnet elements for use in the rotor of FIG. 1;

FIG. 8 is a schematic wiring diagram of the stator of FIG. 6;

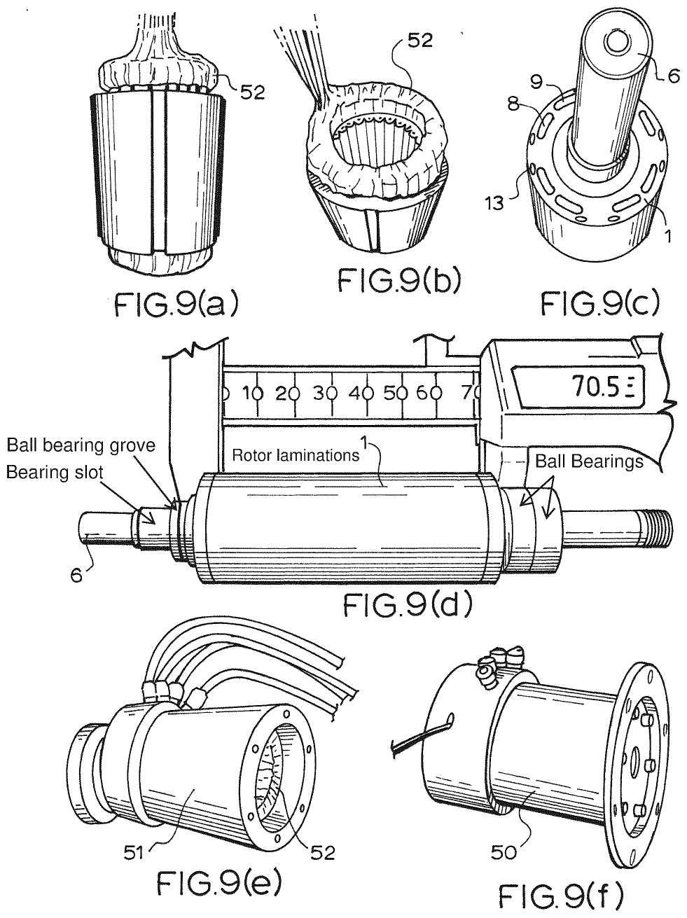

FIG. 9 showed various photos of the motor of FIG. 5;

FIG. 10 is a representation of the test system for the motor of FIG. 5; and

FIG. 11 is a representation of the electronic control system for the motor of FIG. 5;

FIG. 12 is a representation of the rotor of FIG. 1 showing a preferred magnetisation direction for magnet;

FIG. 13 is a representation of a segment of a rotor according to a preferred embodiment setting out preferred geometric parameter;

FIG. 14 is a representation of parameters associated with each pair of tangentially connected curves of the magnet apertures of the rotor of FIG. 1;

FIG. 15 is a representation of parameters associated with the position of the flux barriers the rotor of FIG. 1; and

FIG. 16 is a front view of a 6-pole motor rotor according to preferred embodiments.

### DESCRIPTION OF EMBODIMENTS

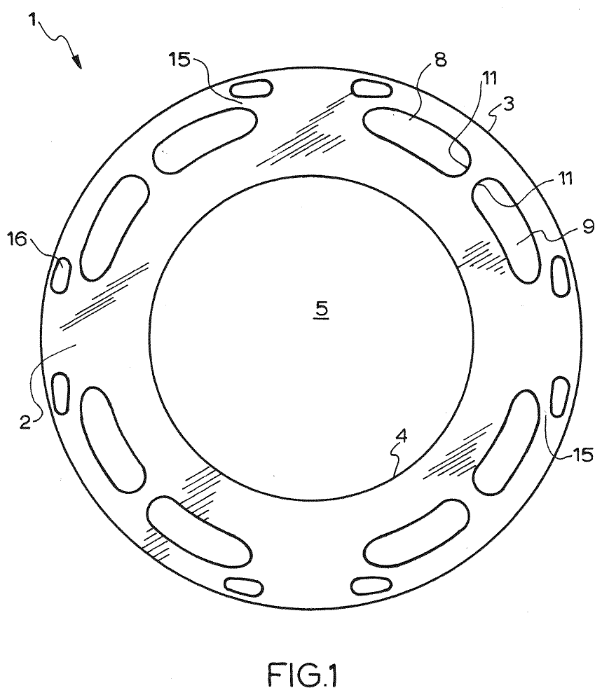

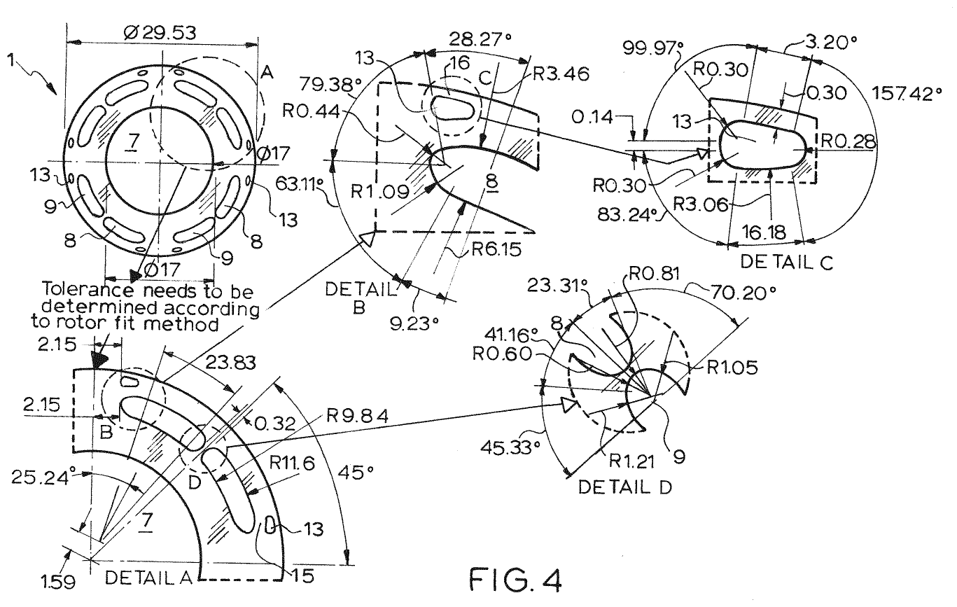

Referring to the drawings generally, like reference numerals have been used to denote like components unless expressly denoted otherwise. Referring firstly to FIGS. 1 to 4, there is shown various views of the 4-pole interior permanent magnet motor rotor 1 according to the preferred embodiment.

The rotor 1 is formed from a ferromagnetic material and includes an annulus 2 having an outer radius 3 and an inner radius 4. Inner radius 4 forms an aperture 5 for receiving a motor shaft 6 therethrough. The rotor of the preferred embodiment includes four quadrants 7 which each includes a pair of permanent magnet apertures 8, 9 symmetrically disposed about a quadrant centreline 10.

The quadrant centreline 10 extends radially from the centre of the annulus 2 to the outer radius 3 equally dividing each quadrant 7. It can be seen that each permanent magnet aperture 8, 9 is disposed each side of the centreline 10 and each has a proximal end 11 adjacent the centreline 10 and an opposing distal end 12.

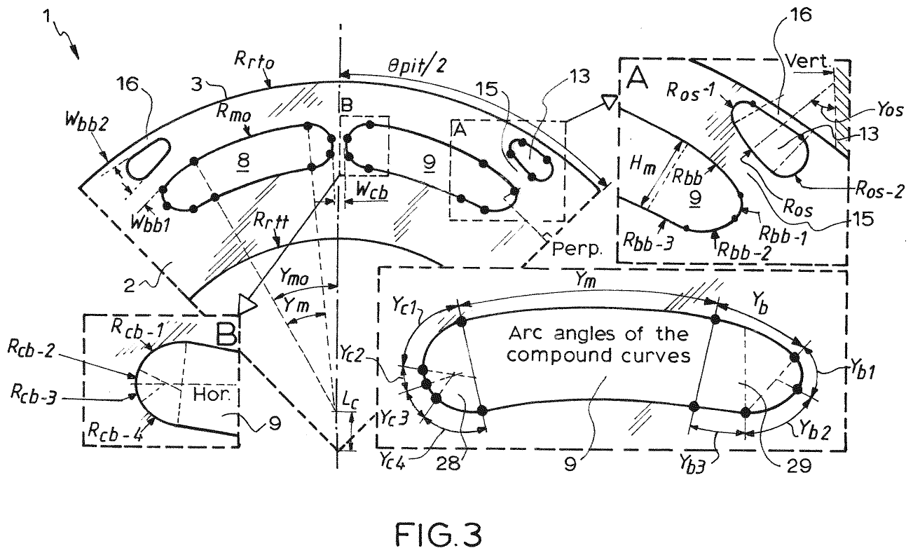

Associated with each permanent magnet aperture 8, 9 is a flux barrier aperture 13 wherein each flux barrier aperture 13 is located intermediate a permanent magnet aperture 8 or 9 and the rotor outer radius 3 adjacent to the distal end 12 of the associated permanent magnet aperture 8 or 9. In this way the rotor 1 includes a primary bridge 15 located between the permanent magnet aperture 8 or 9 and the associated flux barrier aperture 13 and has a predetermined thickness being the distance between the two. A secondary bridge structure 16 is disposed intermediate each flux barrier aperture 13 and the rotor outer radius 3 and it can be seen that the secondary bridge has a thickness that is less than the primary bridge thickness. The dimension of the rotor 1 of the preferred embodiment are shown in FIG. 3.

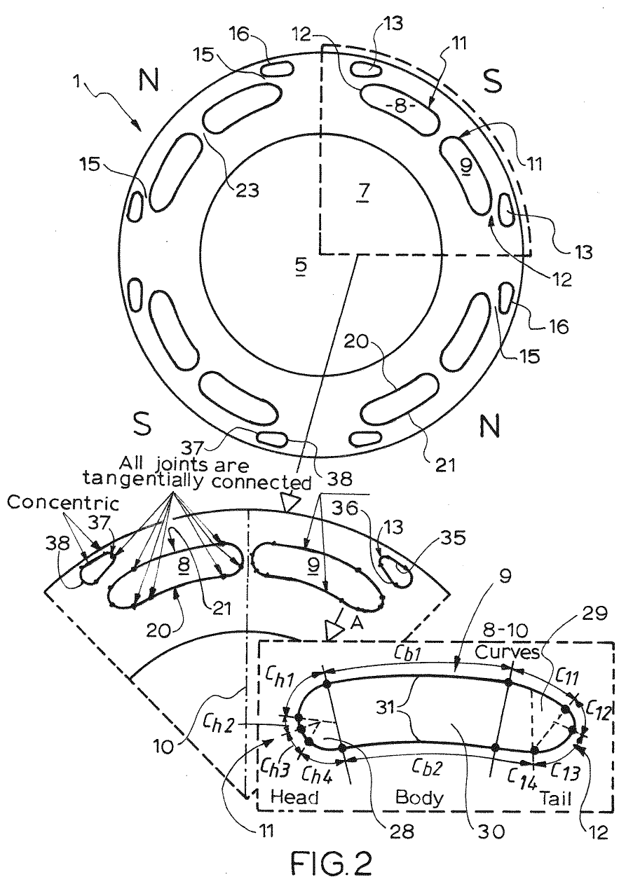

In the rotor 1 of the preferred embodiment, the permanent magnet apertures 8, 9 in each quadrant 7 are shaped to receive a correspondingly shaped magnet or magnet arrangement 25 which is shown formed from a pair of spaced magnet elements 25A, 25B. It will be understood the magnet apertures 8, 9 each receive a permanent magnet having the same polarity and the opposite quadrant magnets in those apertures 8, 9 are of the opposite polarity. FIG. 2 shows magnet apertures 8, 9 being located symmetrically with respect to the quadrant centreline 10.

Each permanent magnet aperture 8, 9 includes an inside edge 20 and a spaced apart opposing outside edge 21. As shown, the inside edge 20 is disposed closer to the inner radius 4 than the outside edge 21. Further, each inside and outside edge 20, 21 extend intermediate the distal 12 and proximal 11 ends so that adjacent the distal end 12 of each permanent magnet aperture 8, 9 at the inside edge 20 lie on a chord extending from the outer radius 3 at one end of the quadrant 7 to the opposed quadrant outer end. That is, a chord is so defined across each quadrant.

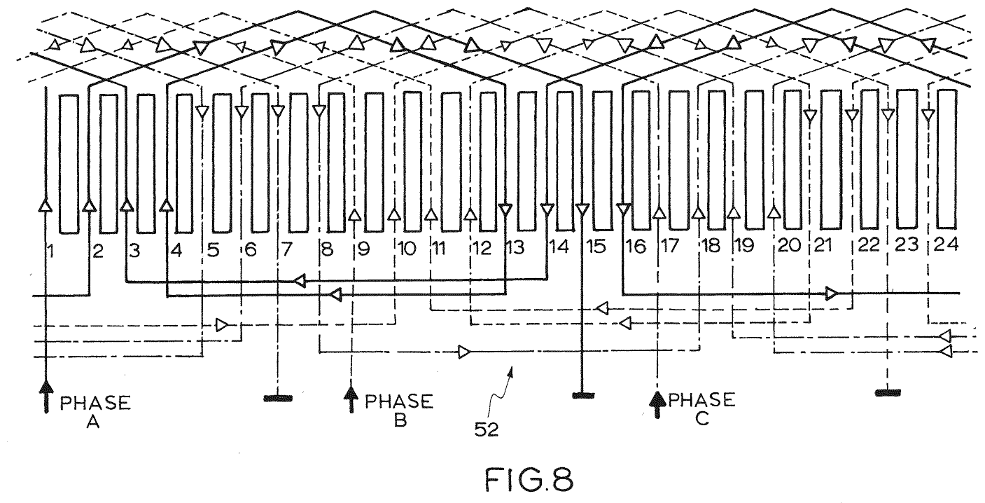

As described in more detail below, each of the permanent magnet apertures 8, 9 have a perimeter defined by a plurality of tangentially connected compound curves and distance intermediate the proximal ends 11 of each permanent magnet apertures 8, 9 symmetric and defines a central bridge 15. Each rotor quadrant 7 is configured to receive a permanent magnet arrangement 25 (see FIG. 7) having and together define a rotor pole.

Furthermore, each permanent magnet aperture 8, 9 can be divided into a head portion 28 that extends from the proximal end 11 to terminate at a body portion 30. The body portion 30 terminates at a tail portion 29 a predetermined distance from distal end 12. The tail portion 29 extends to distal end 12. Here, each of the head 28 and tail 29 portions of the permanent magnet apertures 8, 9 are defined by at least three and preferably four tangentially connected neighbouring curves and the body portion 30 is defined by a pair of body part curves 31 concentric with each other but not the rotor outer radius 3.

As noted that the following limitations or constraints are applied to the rotor 1 of the preferred embodiment. All curves of the magnet apertures 8, 9 and the flux barriers 13 are tangentially connected together. This is best seen in FIG. 2. Further, the inner edge of the secondary bridge structure 16 and the rotor 1 outer radius or edge 3 are concentric. Each pole of the rotor 1 is symmetric about the middle line or segment centreline 10 of the pole. Lastly, it can be seen that all rotor poles or segments of the rotor 1 are substantially identical circular sectors and the minimum width of the primary bridge 15 is larger than that of the secondary bridge 16.

Turning to the flux barrier apertures 13, each of these have a perimeter defined by a plurality of tangentially connected compound curves, as described further below. It will be seen that each flux barrier aperture 13 has an outer side 35 disposed adjacent the rotor outer radius 3 and an opposed inner side 36. Each side 35, 36 extends between a proximal edge 37 closest to the centreline 10 and an opposing distal edge 38. Importantly, at least a portion of the outer edge 37 of each flux barrier aperture 13 is concentric with the rotor outer radius 3.

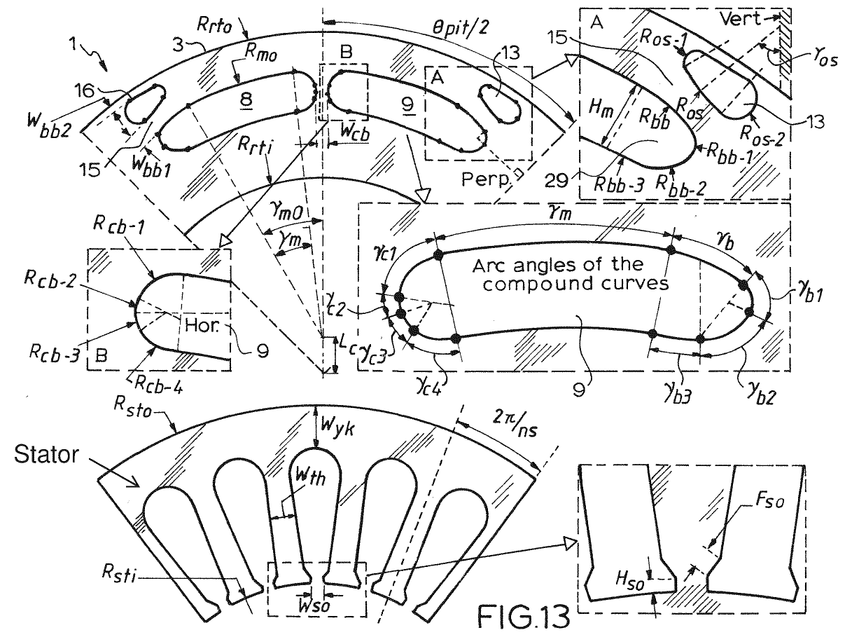

In a preferred embodiment, the rotor 1 of the preferred embodiment is disposed with an IPMSM 50. The motor 50 include a housing 51 having a plurality of radially spaced apart stator field windings 52 and a centrally disposed rotor shaft 6 having an internal permanent magnet rotor 1 mounted thereabout. FIG. 12 shows a representation of the rotor 1 polarity with alternating poles (segments 7). It will be appreciated that the magnetization direction of the magnets in magnet apertures 8, 9 can be radial or parallel as desired.

In the preferred embodiment, rotor 1 and motor 50 have the following characteristics:

| Parameters | | DAB-type | |
|---|---|---|---|
| Rsti | Stator inner radius | 15.27 | mm |
| Wth | Stator tooth width | 2.34 | mm |
| Hsyk | Stator yoke height | 5.94 | mm |
| Wso | Slot width | 1.05 | mm |
| L_{c} | Magnet centre height | 1.59 | mm |
| Rmo | Magnet outer radius | 11.6 | mm |
| γₘ | Magnet arc angles | 23.83° | |
| | | 26.64° | |
| Wcb | Center bridge width | 0.32 | mm |
| Rcb-1 | Center bridge radius | 1.05 | mm |
| γc1 | Center bridge arc angle | 70.2° | |
| Wbb1 | Main bilateral bridge width | 0.77 | mm |
| Rbb-1 | Bilateral bridge radii | 3.46 | mm |
| | | 0.44 | mm |
| γ_{b} | Bilateral bridge arc angle | 28.27° | |
| Hₘ | Magnet height | 1.76 | mm |
| Wbb2 | 2^{nd} bilateral bridge width | 0.3 | mm |
| γoc | Bridge positioning angle | 49.06° | |
| lst | Stack length | 59 | mm |

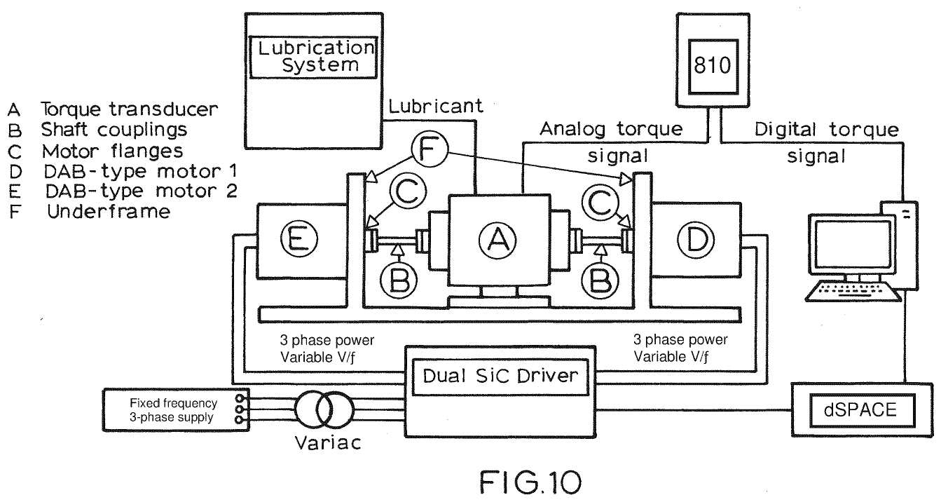

The assembly method for each component of the motor 50 of the preferred embodiment is, briefly, as follows:
1) The high-precision electrical discharge wire cutting method is preferred for machining the rotor laminations.
2) The stator laminations are welded together via the specifically prepared notches. The welded stator is shown in FIG. 9(a).
3) The stator windings are hand winded into the stators due to the small size of the stator and narrow slot opening. The winded stator is shown in FIG. 9(b). However, for stator designs with a relatively larger size, the automatic winding method may be applicable.
4) Two PT100 thermal sensors were winded into the stator slots with an angular difference of 90° to monitor the stator thermal condition.
5) The rotor laminations are shrink-fitted onto the shaft to avoid using keys that could affect the shaft integrity. FIG. 9(c) shows the assembled rotor laminations.
6) The assembled rotor is balanced to the balance quality grade G6.3. A different balancing grade should be considered carefully for designs with a different maximum speed. The balancing is performed by engraving the rotor endplates at specific points.
7) The magnets are molded the desired shape (shown in FIG. 7). The magnet coat should be selected carefully based on the working environment of the motor.
8) The manufactured magnets should have a sliding fit tolerance with the magnet slots. A high precision machining process (before the coating process) may be needed to ensure the magnets have an accurate dimension.
9) The magnets are designed to slide into the slots (sliding fit) and then secured using high-strength adhesive.
10) Each shaft end is equipped with two bearings to strengthen the stiffness of the rotary system, as shown in FIG. 9(d). The bearings are pre-loaded with spring washers to provide 40 Newton and a static axial stiffness of 37 N/μm. A different bearing arrangement should be considered carefully for designs with different ratings.
11) A water jacket, casing, and end plates are assembled and shown in FIG. 9(e). The assembled prototype motor is shown in FIG. 9(f).

It should be noted that 70.5 mm shown on the calliper is a rough reference of the rotor size. The precise length of the rotor laminations plus the end plates is 73 mm. Two identical motors 50 were built so that one of them can work as the loading machine for testing loaded performances of the rotor 1.

It is believed rotor 1 is electrically capable of delivering 5 kW at 100,000 rpm and achieving the target CPSR by implementing field weakening. The electromagnetic performances of the motor 50 achieved high efficiencies>93% at the base speed, impressive power densities>4.4 kW/kg, and low dependency on the rare-earth magnet with torque-per-magnet-weight>25.5 Nm/kg. With the selected high-strength lamination as rotor material, motor 50 achieved a structural safety factor of 1.53 where a structural safety factor higher than 1.5 should be guaranteed to avoid mechanical failures caused by metal fatigue. In the unique rotor structure of the preferred embodiments, flux barrier and magnets provide the IPMSM rotor a significantly improved mechanical robustness. This is particularly when compared to either the conventional flat-type and V-type rotor topologies, as the preferred embodiments reduce the maximum mechanical stress by 35%-57% under the same operating condition.

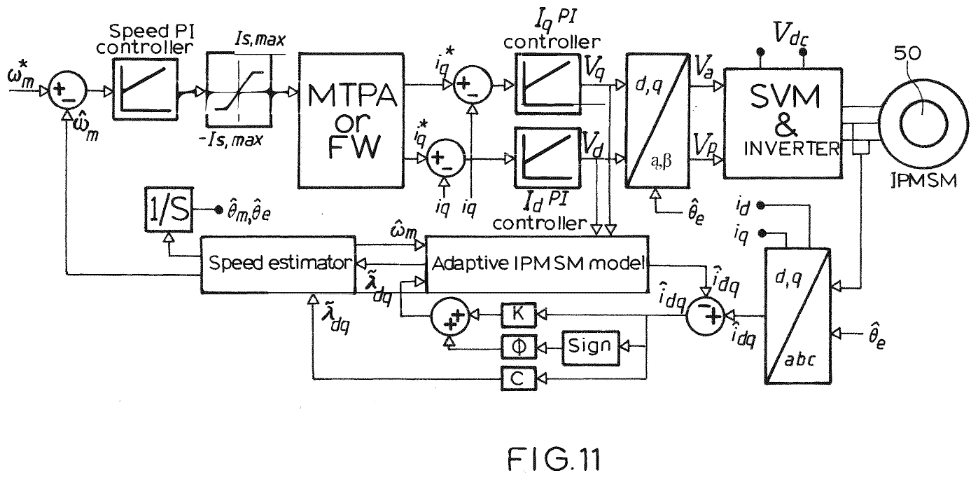

The arrangement of FIG. 10 shows a diagram of a motor test system. Here, two identical motors 50 were coupled back-to-back via a high-speed torque transducer ET0044 MK2, whose measurement capacities are 120,000 rpm, 1.4 Nm. One of the motors 50 was used as the driving motor, whereas the other one served as the generator load. The generated power is feedback to the shared DC bus of two silicon-carbide (SiC) inverters. The two SiC inverters are equipped with two sets of sensors, and hence, both inverters can be controlled independently.

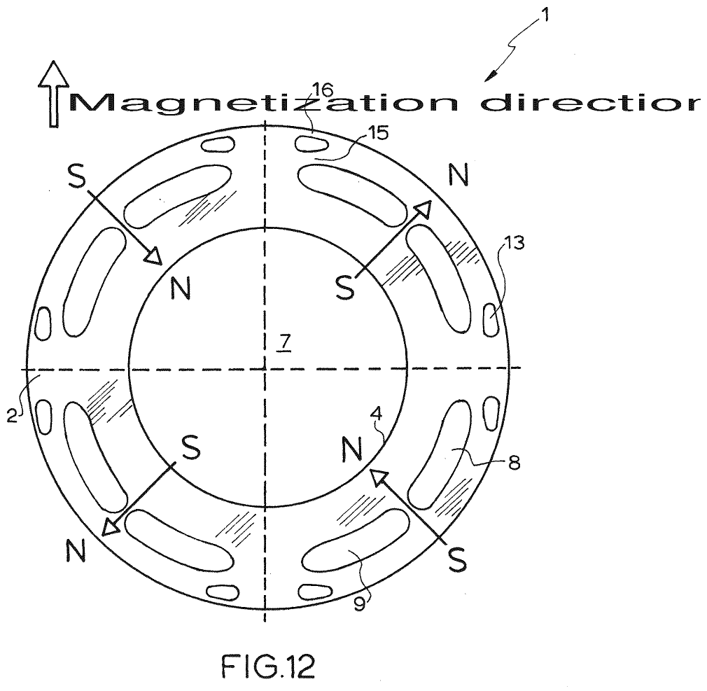

A computer interface is used to input parameters, speed, and torque commands to the controllers and monitor the motors 50 operating conditions. A block diagram of the adopted sensorless sliding-mode control is shown in FIG. 11. At low speeds<1000 rpm, the high frequency injection algorithm was adopted; at any speeds≥1000 rpm, the SMO was used for position detection.

Before performing the load tests, the structural reliability of the motor 50 was first investigated via a high-speed rotation test, in which the uncoupled prototype was independently controlled to accelerate from 0 to 100,000 rpm in steps of 5000 rpm. The prototype was controlled sensorlessly using a sliding mode observer. This provided a maximum vibration value of 5 m/s² occurred at 100,000 rpm. The maximum noise level of 77.8 dB did not exceed the exposure standard required for working safely without additional noise protection equipment.

Most advantageously, it was found that after operating the motor 50 at 100,000 rpm continuously for 60 minutes rotor 1 was still intact after the high-speed rotation at 100,000 rpm. There was no visible deformation on the rotor 1 surface or the bearing outer surface, which confirms the mechanical robustness of the rotor 1. At 100,000 rpm, the rotor tip speed is around 153 m/s, which is within the typical “high-speed” range of 100-250 m/s and rotor 1 was shown to be mechanically suitable for high-speed applications.

The main performances of the motor 50 over the whole torque-speed region were investigated and the efficiency, shaft output power, input current, and power factor were obtained at multiple sample loading points. From the measured data the motor 50 achieved maximum efficiency of 93.5% and efficiencies higher than 90% in half of the operating region. The closer the operating point gets to the rated condition, the more efficient. The measured efficiency at the base speed under the full load is around 93% and at 80,000 rpm under the full-load condition, the prototype still achieved an acceptable efficiency of around 91%.

It was found that the motor 50 achieved target power ratings at speeds up to 80,000 rpm. Between 50,000 and 70,000 rpm, the motor 50 can supply powers higher than 5500 W because it can utilise a substantial proportion of reluctance torque while implementing flux weakening. At 80,000 rpm, the prototype can produce a maximum power of around 5356 W, producing a high-speed coefficient of 1.85×10⁵ rpm√kW. It is believed IPMSM motor 50 successfully exceeded the existing limit of laminated rotor IPMSM in terms of the rpm √kW where previously the limit was achieved by a flat-type IPMSM, of which the ratings are 11 kW, 50,000 rpm, and 1.66×10⁵ rpm√kW (see Yonda et al). It is noted that by replacing bearings with higher-precision bearings, the motor 50 could achieve an even higher rating of 2.31 rpm√kW at 100,000 rpm.

It was found that the current required to provide a constant torque is generally steady as a straight line in the constant torque speed region. Furthermore, in the constant power speed region, the contour lines of lower currents barely change with the speed, but the contour lines representing currents that are higher than 7 Arms start to bend downward. Further, motor 50 tended to have a higher power factor at high speeds, and the maximum power factor was found near the 80,000 rpm half-power operating point. At the point of full load 50,000 rpm, the measured power factor is around 0.72 which is acceptable.

### Key Specifications of the Developed IPMSM Prototype Having Rotor 1.

### Key Dimensions

| | | | | | |
|---|---|---|---|---|---|
| Stator outer | 64.3 | mm | Rotor centre bridge | 0.32 | mm |
| diameter | | | width | | |
| Stator inner | 30.47 | mm | Main bilateral bridge | 0.77 | mm |
| diameter | | | width | | |
| Stator tooth width | 2.34 | mm | Second bilateral bridge | 0.3 | mm |
| | | | width | | |
| Stator slot opening | 1.05 | mm | Magnet thickness | 1.56 | mm |
| Stator lamination | 0.1 | mm | Rotor lamination | 0.35 | mm |
| thickness | | | thickness | | |
| Airgap height | 0.5 | mm | Shaft diameter | 17 | mm |
| Rotor diameter | 29.53 | mm | Stack length | 65 | mm |

| | | | | |
|---|---|---|---|---|
| Rotor lamination | 0.35 | mm | Rotor skew angle | 10° |
| thickness | | | | |

### Design Specifications

| Slot-pole combination | 24 slots, 4 poles | |
|---|---|---|
| Winding type | Single-layer distributed | |
| Slot fill factor | 58% | |
| Number of turns per coil | 9 turns | |
| Diameter of each conductor strand | 0.6 | mm |
| Conductor insulation type | Corona-resistant enamelled | |
| Cooling arrangement | Water jacket cooling | |
| Number of magnet pieces | 16 pieces | |
| Stator lamination material | 10JNEX900 | |
| Core loss density of stator lamination | 5.7 W/kg @ 1T, 400 Hz | |
| Rotor lamination material | B35AHS500 | |
| Core loss density of rotor lamination | 23 W/kg @ 1T, 400 Hz | |
| Rotor lamination yield stress | 500 | MPa |

| | |
|---|---|
| Magnet grade | NdFeB N40UH |
| Magnet coating | Black Epoxy (Ni—Cu—Be) |

| Rated voltage (RMS) | 340 V (Line-Line) | |
|---|---|---|
| Rated current (RMS) | 15 | A |
| Base/Maximum speed | 50,000 rpm/100,000 rpm | |
| Rated torque at base speed | 0.988 | Nm |
| Maximum efficiency | 93.5% incl mechanical and | |
| | inverter losses | |
| d-axis inductance (at rated condition) | 0.6538 | mH |
| q-axis inductance (at rated condition) | 1.364 | mH |
| Stator DC resistance @ 25° C. | 0.17 | Ω/phase |
| Magnet flux linkage @ 25° C. | 0.01536 | Wb |
| Inverter switching frequency | 80 | kHz |
| Inverter DC bus voltage | 500 | V |

Although not illustrated, it will be appreciated that that the 4-pole rotor 1 of the preferred embodiment can similarly be modified to include 2N poles where N is an integer greater than 1 (i.e. 1, 2, 3, etc). Maintaining like reference numerals for ease of description, such a multi-pole interior permanent magnet motor rotor 1 includes an annulus 2 having an outer radius 3 and an inner radius 4 forming an aperture 5 configured to receive the motor shaft 6 therethrough and be retained about it.

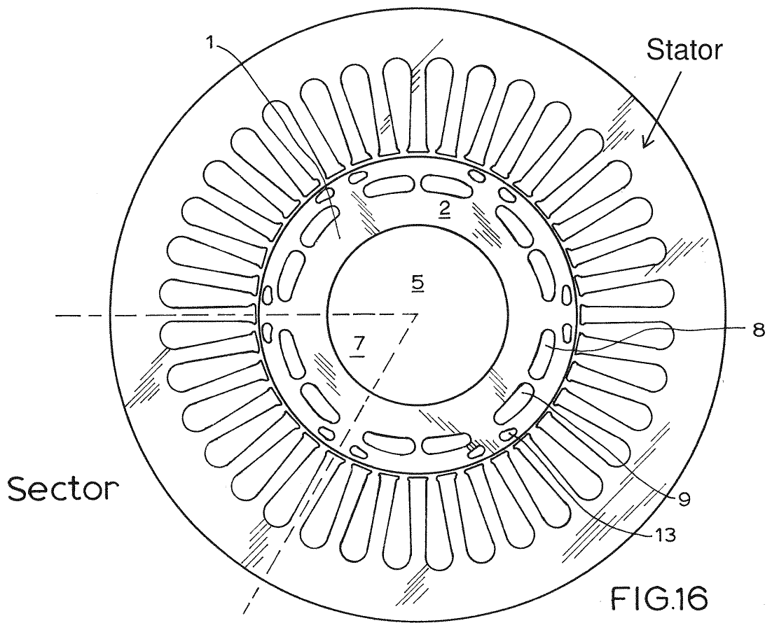

Rather than quadrants 7, a plurality of sectors are provided. There are 2N equi-sized sectors each including a pair of permanent magnet apertures 8, 9 symmetrically disposed about a sector centreline 10 and extending radially from the centre of the annulus 2 to the outer radius 3 so as to equally divide each sector. As with the 4-pole rotor 1, each permanent magnet aperture 8, 9 is disposed each side of the centreline 10 and has a proximal end 11 adjacent the centreline 10 and an opposing distal end 12. Similarly in this embodiment, the flux barrier aperture 13 associated with each permanent magnet aperture 8, 9 is disposed intermediate aperture 8, 9 and the rotor 1 outer radius 3 adjacent to the distal end 12 of the associated permanent magnet aperture 8, 9. Reference is made to FIG. 16 illustrating a 6-pole rotor.

The rotor 1 includes a primary bridge 15 disposed intermediate the permanent magnet aperture 8, 9 and the flux barrier aperture 13 defining a predetermined bridge thickness. The secondary bridge 16 is disposed intermediate the flux barrier aperture 13 and the rotor outer radius 3 defining a predetermined secondary bridge thickness. The primary bridge thickness is greater than the secondary bridge thickness.

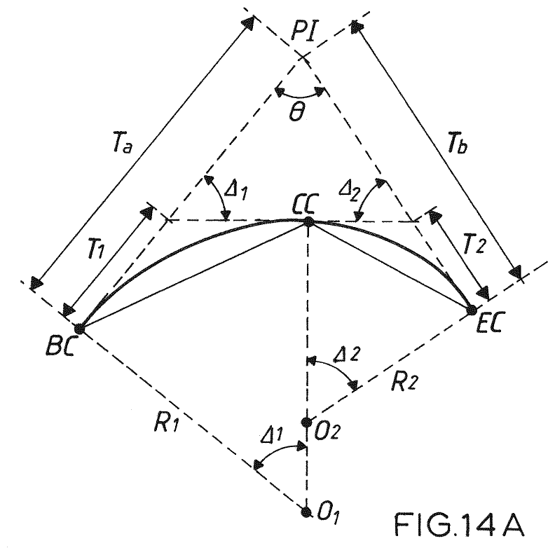

Turning now to FIG. 13, there is shown a representation of the geometric parameters associated with a preferred embodiment of rotor 1 in a motor 50. The rotor 1 and motor 50 have the following preferred characteristics:

Stator Parameters

| | |
|---|---|
| nₛ | Stator slot number |
| Rₛₜₒ | Stator outer radius |
| g | Airgap height |
| Hₛₒ | Stator slot opening height |
| Fₛₒ | Stator slot feet width |
| Rₛₜᵢ | Stator inner radius |
| Wₜₕ | Stator tooth width |
| H_{syk} | Stator yoke height |
| Wₛₒ | Stator slot opening width |

Rotor parameters

| | |
|---|---|
| nₚ | Pole number |
| Rᵣₜᵢ | Rotor inner diameter |
| R_{bb-2} | Bilateral bridge radius |
| L_{c} | Magnet centre height |
| Rₘₒ | Magnet outer radius |
| γₘ₀ | Magnet arc angles |
| γₘ | |
| W_{cb} | Centre bridge width |
| R_{cb-1, 2, 3 . . .} | Centre bridge radius |
| γ_{c1} | Centre bridge arc angle |
| W_{bb1} | Main bilateral bridge width |
| R_{bb} | Bilateral bridge radii |
| R_{bb-1, 2, 3 . . .} | |
| γ_{b} | Bilateral bridge arc angle |
| Hₘ | Magnet height |
| Rₒₛ₋₁ | Open-spandrel radii |
| Rₒₛ₋₂ | |
| W_{bb2} | 2^{nd} bilateral bridge width |
| γ_{oc} | Bridge positioning angle |

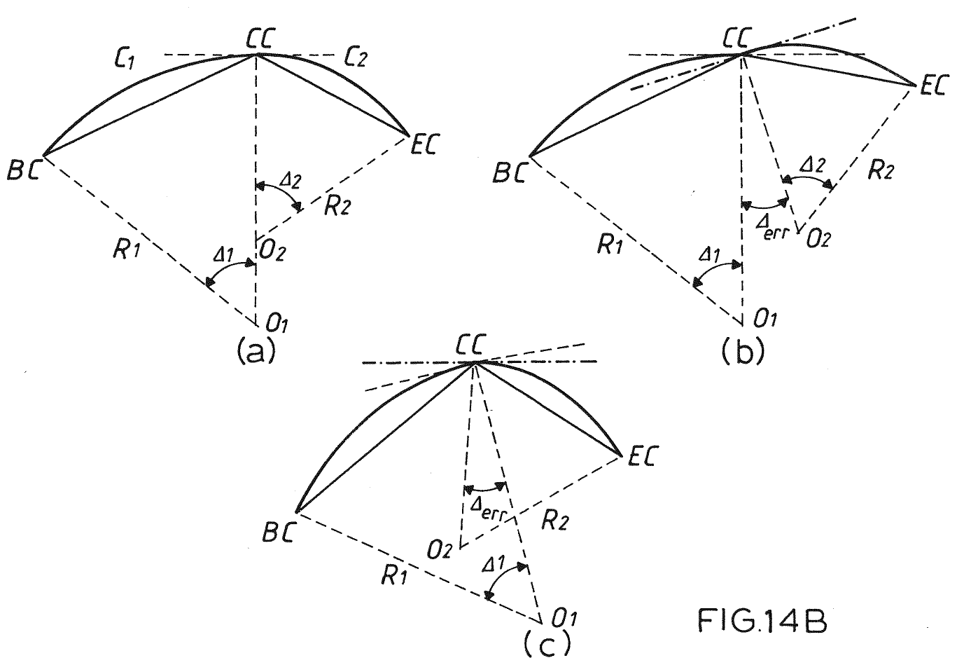

Following in FIG. 14A, there is shown the relationship whereby the tangentially connected curves of the magnet apertures 8, 9 and of the flux barrier apertures 13 preferably satisfy the conditions:

$$\{ \begin{matrix}{T}_{1} = {R}_{1} tan \frac{{Δ}_{1}}{2} \\ {T}_{2} = {R}_{2} tan \frac{{Δ}_{2}}{2}\end{matrix} \\ \{ \begin{matrix}{T}_{a} = \frac{{R}_{2} - ( {R}_{1} sin Θ ) + [ ( {R}_{1} - {R}_{2} ) cos {Δ}_{2} ]}{cos Θ} \\ {T}_{b} = \frac{{R}_{1} - ( {R}_{2} sin Θ ) - [ ( {R}_{1} - {R}_{2} ) cos {Δ}_{1} ]}{cos Θ}\end{matrix} \frac{{T}_{a} - {T}_{1}}{sin {Δ}_{2}} = \frac{{T}_{1} + {T}_{2}}{sin Θ}$$

where R₁ and R₂ are radii of the first and second curves, respectively; Δ₁ and Δ₂ are arc angles of the first and second curves, respectively. The dashed lines T₁ and T₂ are tangential to the first and second curves, respectively.

In reference to FIG. 14B, it is noted that ideally all neighbouring curves forming apertures 8,9 & 13 of the rotor 1 should be strictly tangential to each other to avoid causing undesirably high mechanical stresses around the joint. However, a certain extent of approximation/misalignment is generally allowed. If two curves are strictly tangential to each other, the line CC-O₁ should be aligned with the line CC-O₂, as shown in FIG. 14B (a). When the two curves are not perfectly tangential to each other, there will be an error angle Δₑᵣᵣ formed between CC-O₁ and CC-O₂, as shown in FIG. 14B (b) and (c).

It can be seen that in the preferred embodiment that Line CC-O₁ connects the joint (point CC in the figure) and centre of the first curve (point O₁ in the figure); Line CC-O₂ connects the joint (point CC in the figure) and centre of the second curve (point O₂ in the FIG. 14B).

It will be appreciated that in preferred embodiments the tangential error angle Δₑᵣᵣ should be within the range of −20°<Δₑᵣᵣ<20° to avoid a severe or undesirable degradation of the motor performance.

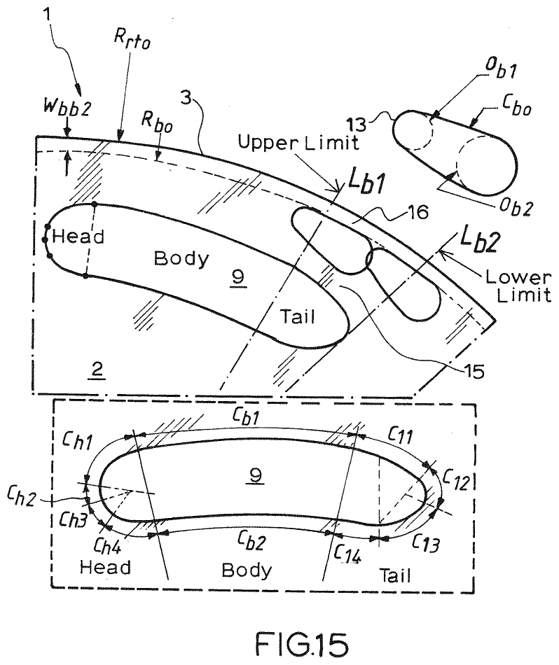

Referring to FIG. 15, there is shown a representation of the constraints on the positioning of the flux barrier aperture 13 radially with respect to the adjacent magnet aperture 8 or 9. The flux barrier apertures 13 must serve the function of limiting undesirable leakage magnetic flux via the bridges 15 & 16. As such, flux barrier apertures 13 in the rotor 1 of the preferred embodiment are located within a radially constrained area between “Lower Limit” and “Upper Limit” shown in FIG. 15.

In the preferred embodiment, the outer edge of the flux barrier aperture 13 C_{bo} is concentric with the rotor outer edge 3 (Rᵣₜₒ). Therefore, the flux barrier aperture 13 can only move along the dashed curve shown in FIG. 15. The dashed line is concentric with the rotor outer edge 3 and it has a radius defined as R_{bo}=Rᵣₜₒ−W_{bb2}.

To ensure the flux barrier aperture can serve its function of blocking leakage flux, the flux barrier aperture cannot exceed the upper and lower limits while moving along the dashed line. Located outside of these limits, undesirably large flux leakage or high mechanical stress occurs.

It can be seen that the Upper limit L_{b1} can be represented by the extended line that divides the body portion 30 and tail portion 29 of the magnet aperture 9. The Lower limit L_{b2} is represented the line that is tangential to curves of the magnet tail part at the joint of Cₜ₂ and Cₜ₃. It will be appreciated by those skilled in the art that in the preferred embodiments adjacent circles Ob₁ and Ob₂ must be fully or partially accommodated in the area between L_{b1} and L_{b2}.

It will be appreciated that the rotor 1 of the preferred embodiments significantly improves the mechanical robustness of the rotor while maintaining the advantages of the interior permanent magnet motor, i.e. high efficiency, high power density, and having a wide constant-power-speed-range.

The foregoing describes only one embodiment of the present invention and modifications, obvious to those skilled in the art, can be made thereto without departing from the scope of the present invention.

The term “comprising” (and its grammatical variations) as used herein is used in the inclusive sense of “including” or “having” and not in the exclusive sense of “consisting only of”.

1. A multi-pole interior permanent magnet motor rotor comprising an annulus having an outer radius and an inner radius forming an aperture configured to receive a motor shaft therethrough, the rotor having four quadrants wherein each quadrant includes a pair of permanent magnet apertures symmetrically disposed about a quadrant centreline extending radially from the centre of the annulus to the outer radius equally dividing each quadrant such that each permanent magnet aperture is disposed each side of the centreline and each aperture having a proximal end adjacent the centreline and an opposing distal end, a flux barrier aperture associated with each permanent magnet aperture wherein each flux barrier aperture is disposed intermediate a permanent magnet aperture and the rotor outer radius adjacent to the distal end of the associated permanent magnet aperture, the rotor including a primary bridge disposed intermediate the permanent magnet aperture and the flux barrier aperture wherein the primary bridge has a predetermined thickness and a secondary bridge disposed intermediate the flux barrier aperture and the rotor outer radius wherein the secondary bridge has a predetermined thickness that is less than the primary bridge thickness.

2. A rotor according to claim 1 wherein each permanent magnet aperture includes an inside edge and a spaced apart opposing outside edge such that the inside edge is disposed closer to the inner radius than the outside edge, each inside and outside edge extending intermediate the distal and proximal ends such that adjacent the distal end of each permanent magnet aperture at the inside edge lie on a chord extending from the outer radius at one end of the quadrant to the opposed quadrant outer end.

3. A rotor according to claim 1, wherein each of the permanent magnet and flux barrier apertures have a perimeter defined by a plurality of tangentially connected compound curves.

4. A rotor according to claim 1, wherein distance intermediate the proximal ends of each permanent magnet aperture is symmetric about the quadrant centreline and defines a central bridge such that each rotor quadrant is configured to receive two permanent magnets together configured to define a rotor pole.

5. A rotor according to claim 1, wherein each flux barrier aperture having an outer side disposed adjacent the rotor outer radius and an opposed in a side, each side extending between a proximal edge closest to the centreline and an opposing distal edge, at least a portion of the outer edge of each flux barrier aperture is concentric with the rotor outer radius.

6. A rotor according to claim 1, wherein each permanent magnet aperture is composed of a head portion adjacent the quadrant centreline extending from proximal end thereof and terminating at the tail portion at the distal end wherein a body portion is disposed intermediate the head and tail portions.

7. A rotor according to claim 6, wherein each of the head and tail portions of the permanent magnet aperture are defined by at least three and preferably four tangentially connected neighbouring curves; and the body portion is defined by a pair of body part curves concentric with each other but not the rotor outer radius.

8. A rotor according to claim 1, wherein the permanent magnet apertures in each quadrant are configured to receive a permanent magnet having the same polarity and a substantially symmetric with respect to the centreline.

9. A rotor according to claim 1, wherein the permanent magnet apertures are configured to have magnets of opposite poles in adjacent quadrants.

10. A multi-pole interior permanent magnet motor rotor comprising an annulus having an outer radius and an inner radius forming an aperture configured to receive a motor shaft therethrough, the rotor having 2N equi-sized sectors where N is an integer equal to or greater than 1, each sector including a pair of permanent magnet apertures symmetrically disposed about a sector centreline and extending radially from the centre of the annulus to the outer radius equally dividing each sector such that each permanent magnet aperture is disposed each side of the centreline and each aperture having a proximal end adjacent the centreline and an opposing distal end, a flux barrier aperture associated with each permanent magnet aperture wherein each flux barrier aperture is disposed intermediate a permanent magnet aperture and the rotor outer radius adjacent to the distal end of the associated permanent magnet aperture, the rotor including a primary bridge disposed intermediate the permanent magnet aperture and the flux barrier aperture wherein the primary bridge has a predetermined thickness and a secondary bridge disposed intermediate the flux barrier aperture and the rotor outer radius wherein the secondary bridge has a predetermined thickness that is less than the primary bridge thickness.

11. An interior permanent magnet electric motor comprising a housing having a plurality of radially spaced apart stator field windings and a centrally disposed rotor shaft having an interior permanent magnet rotor according to claim 1 mounted thereabout.

12. An interior permanent magnet electric motor according to claim 11 including a plurality of interior permanent magnet rotors disposed closely adjacent to or contiguous with each other wherein corresponding permanent magnet apertures and flux barrier apertures on each rotor are radially aligned.
